(19) United States
(12) Patent Application Publication
(10) Pub. No.: US 2026/0267159 A1
(43) Pub. Date: Sep. 10, 2026

(54) SYSTEM FOR SECURING EYEGLASSES TO A WEARER'S HEAD

(71) Applicant: THOMAS TOROK, SIOUX FALLS, SD (US)

(72) Inventor: THOMAS TOROK, SIOUX FALLS, SD (US)

(21) Appl. No.: 19/657,956

(22) Filed: Apr. 24, 2026

Related U.S. Application Data
(63) Continuation-in-part of application No. 18/897,776, filed on Sep. 26, 2024, now Pat. No. 12,677,896.

(51) Int. Cl. G02C 3/02; G02C 3/00

(52) U.S. Cl. CPC G02C 3/02; G02C 3/006

(57) ABSTRACT

A system for removably securing eyeglasses to a head of a person may include a cap with a pair of passages each extending along a different side of the cap. The cap may have a pair of forward apertures and a pair of rearward apertures. Each passage extends between a forward and a rearward aperture on a side of the cap. A retaining assembly for eyeglasses may include a pair of straps with each strap having a medial portion in one of the passages, a first portion extending through the forward aperture, and a second portion extending through the rearward aperture. A first end of a strap may be configured for attaching to the eyeglasses; and a second end of a strap may be attached to the second end of the other strap.

### REFERENCE TO RELATED APPLICATIONS

This application is a continuation-in-part of U.S. patent application Ser. No. 18/897,776, filed Sep. 26, 2024, which is hereby incorporated by reference in its entirety.

### BACKGROUND

### Field

The present disclosure relates to eyeglasses accessories and more particularly pertains to a new system for securing eyeglasses to a wearer's head in, for example, two positions of the eyeglasses on the wearer's head such as on the wearer's face and on a cap worn by the person.

### Description of the Prior Art

Some conventional practices for storing eyeglasses, and particularly sunglasses, on the person of the wearer when not being actively worn include resting the glasses on the visor of a cap without any securing of the glasses to the cap (which relies upon any friction present between the temple pieces of the glasses and the exterior surface of the cap to stay on the cap), or perhaps one of the temple pieces of the glasses through the neck hole of the user's shirt.

Numerous devices with the purpose of holding glasses not been actively used have been proposed. Some devices attempt to provide additional securing of the glasses when the glasses are rested on the visor but are significantly less effective for securing the glasses on the head of the wearer when the glasses are actively being used, if the devices attempt to provide any securing at all of glasses being worn.

### SUMMARY

In one aspect, the present disclosure relates to a system for removably securing eyeglasses to a head of a person. The system may comprise a cap for being worn by the person, with the cap having a top and a bottom, a front and a rear, and opposite sides. The cap may include a crown extending from the bottom of the cap to the top of the cap, a visor extending forwardly from the crown at the front of the cap for positioning above the face of the person, and a perimeter band for extending around the head of the user when the cap is worn on the head. The cap may also include a pair of passages extending along different side portions of the perimeter band, a pair of forward apertures being formed in the crown, with each of the forward apertures being located on one of the sides of the cap and being in communication with one of the passages. The cap may further include a pair of rearward apertures formed in the crown, with each of the rearward apertures being located rearwardly of one of the forward apertures and being in communication with one of the passages such that each of the passages extends between one of the forward apertures and one of the rearward apertures on a said side of the cap. The system may also comprise a retaining assembly mounted on the cap for retaining eyeglasses on the cap. The retaining assembly may include a pair of straps with each of the straps having a medial portion extending in one of the passages of the cap, a first portion extending out of a said passage through the forward aperture of said passage, and a second portion extending out of the passage through the rearward aperture of said passage. A first end on the first portion of the strap may be configured for attaching to one of the temples of the eyeglasses and a second end on the second portion of the strap may be attached to the second end of the other said strap.

In another aspect, the disclosure relates to a system for securing eyeglasses to a head of a person, with the eyeglasses being of a type having a front frame and a pair of temple members extending from the front frame, The system may comprise an article of headwear for being worn by the person. The article has a front and a rear, and opposite sides, and the article has an opening at the bottom for receiving a portion of the head of the person. The article may comprise a perimeter band for extending around the head of the user when the article is worn on the head, and the perimeter band may define the opening of the article. The perimeter band has an inward side oriented toward the head of the user when the article is worn and an outward side oriented away from the head of the user when the article is worn. The perimeter band may include an inward panel portion forming at least a portion of the inward side and an outward panel portion forming at least a portion of the outward side. The article may also comprise a visor extending forwardly from the perimeter band at the front of the article for positioning above the face of the person. The article may further comprise a pair of passages extending along different side portions of the perimeter band, with each of the passages being formed between the inward panel portion and the outward panel portion of the perimeter band. A pair of forward apertures may be formed in the outward side of the perimeter band, and each of the forward apertures may be located on one of the sides of the article and may be in communication with one of the passages. A pair of rearward apertures may be formed in the outward side of the perimeter band, with each of the rearward apertures being located on one of the sides of the article and rearwardly of one of the forward apertures. Each of the rearward apertures may be in communication with one of the passages such that each of the passages extends between one of the forward apertures and one of the rearward apertures on a said side of the article. A retaining assembly may be mounted on the article for retaining eyeglasses on the article. The retaining assembly may comprise a pair of straps, Each of the straps may have a medial portion extending in one of the passages of the article such that the medial portion is located between the inward panel portion and the outward panel portion of the perimeter band. Each of the straps may also have a first portion extending through the forward aperture formed in the perimeter band such that the first portion extends out of the said passage of the perimeter band. Each of the traps may further have a second portion extending through the rearward aperture formed in the perimeter band such that the second portion extends out of the said passage of the perimeter band. A first end on the first portion of the strap may be configured for attaching to a temple member of the eyeglasses. A second end on the second portion of the strap may be attached to the second end of the other said strap.

There has thus been outlined, rather broadly, some of the more important elements of the disclosure in order that the detailed description thereof that follows may be better understood, and in order that the present contribution to the art may be better appreciated. There are additional elements of the disclosure that will be described hereinafter and which will form the subject matter of the claims appended hereto.

In this respect, before explaining at least one embodiment or implementation in greater detail, it is to be understood that the scope of the disclosure is not limited in its application to the details of construction and to the arrangements of the components set forth in the following description or illustrated in the drawings. The disclosure is capable of other embodiments and implementations and is thus capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

The advantages of the various embodiments of the present disclosure, along with the various features of novelty that characterize the disclosure, are disclosed in the following descriptive matter and accompanying drawings.

### BRIEF DESCRIPTION OF THE DRAWINGS

The disclosure will be better understood and when consideration is given to the drawings and the detailed description which follows. Such description makes reference to the annexed drawings wherein:

FIG. 1 is a schematic side view of a person wearing a new system for securing eyeglasses to a wearer's head, with the eyeglasses in a use position, according to the present disclosure.

FIG. 2 is a schematic side view of a person wearing the new system for securing eyeglasses to the wearer's head, with the eyeglasses in a stored position, according to the present disclosure.

FIG. 3 is a schematic top view of the system, according to an illustrative embodiment.

FIG. 4 is a schematic sectional view of a portion of the cap and the retaining assembly taken along line 4-4 in FIG. 3, according to an illustrative embodiment.

FIG. 5 is a schematic side view of a portion of the cap and the retaining assembly, according to an illustrative embodiment.

FIG. 6 is a schematic side view of a person wearing a system for securing eyeglasses having optional features, according to the present disclosure.

FIG. 7 is a schematic side view of a person wearing an additional embodiment of the system for securing eyeglasses to a wearer's head, according to the present disclosure.

FIG. 8 is a schematic top view of the system of FIG. 7, according to an illustrative embodiment.

FIG. 9 is a schematic side view of a portion of the article of headwear and the retaining assembly, according to an illustrative embodiment.

### DETAILED DESCRIPTION

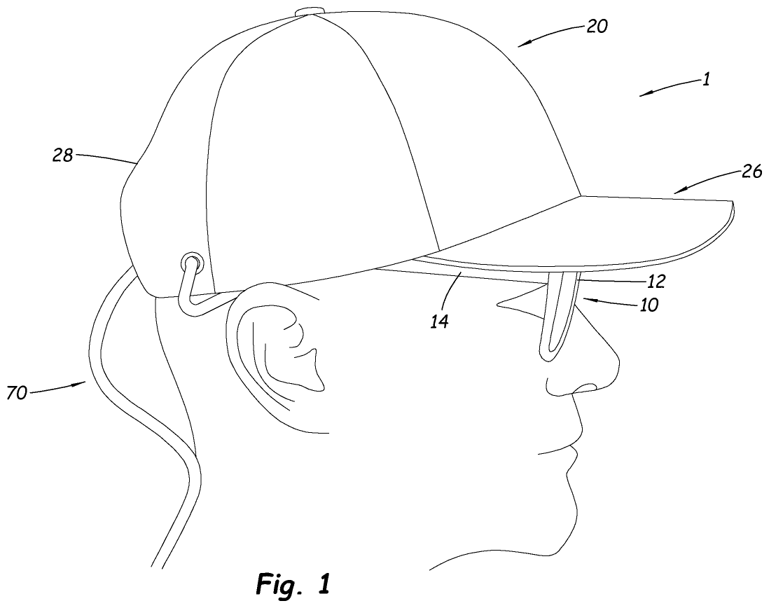

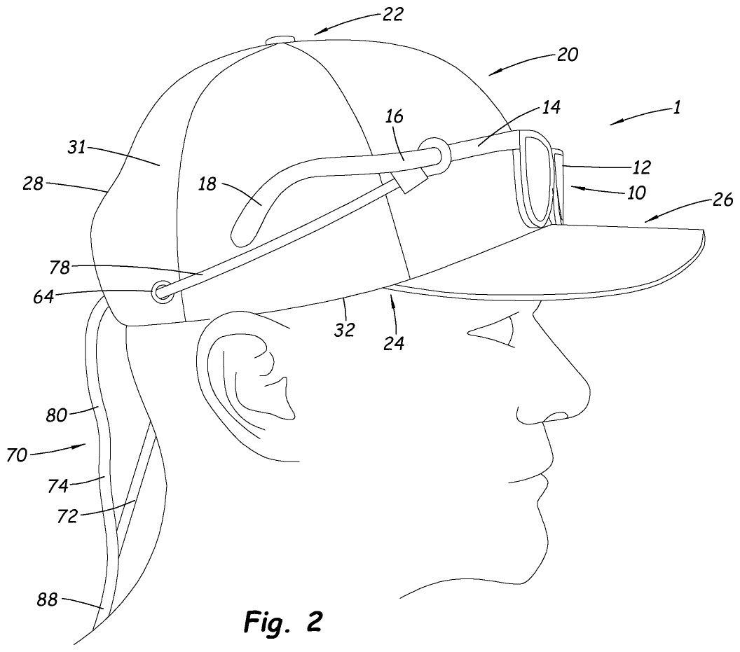

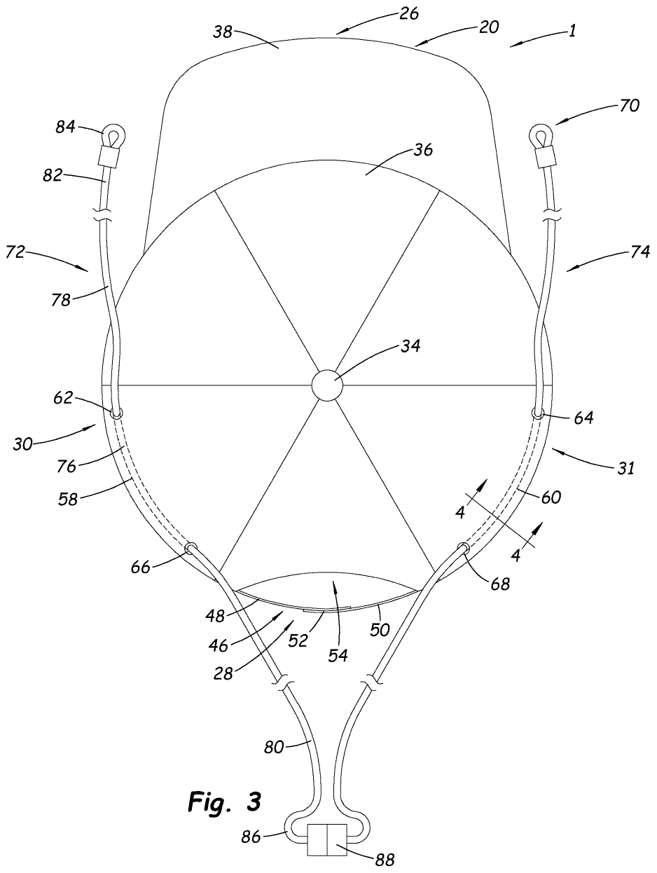

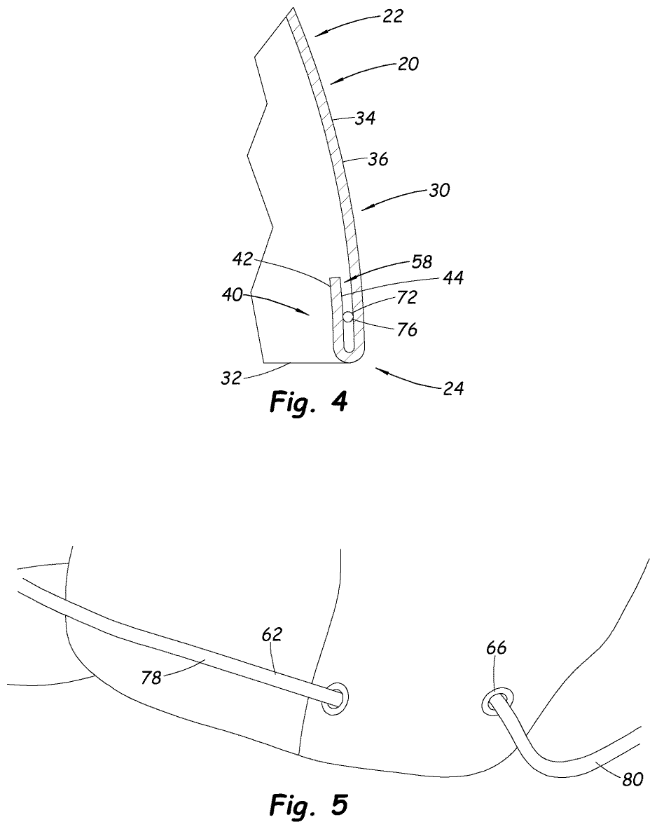

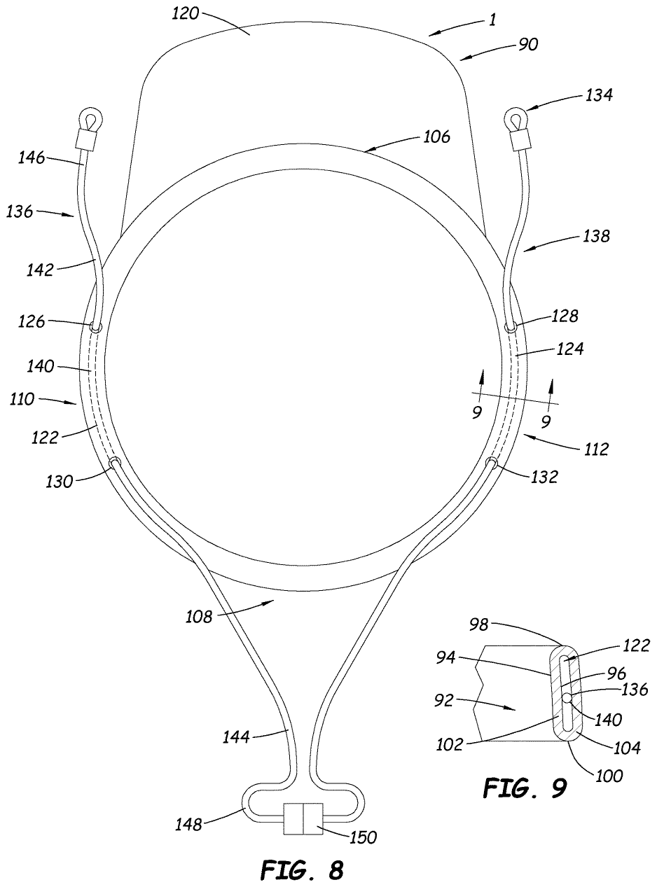

With reference now to the drawings, and in particular to FIGS. 1 through 9 thereof, a new system for securing eyeglasses to a wearer's head embodying the principles and concepts of the disclosed subject matter will be described.

Significantly, the system of the disclosure permits the glasses to be held securely to the head whether the glasses are being worn on the face of the wearer and the glasses are actively being used, or the glasses are being rested on the visor or “bill” of the cap and the glasses are not in use, but are positioned to be placed on the face of the wearer without significant effort).

Aspects of the disclosure relate to a system 1 for removably securing eyeglasses to the head of the user or wearer of the eyeglasses. Typically, the eyeglasses comprise sunglasses, although other types of glasses are also suitable for use with the system.

In some embodiments, the system 1 may include the eyeglasses 10 which comprise a front frame 12 and a pair of temple members 14, 16 that are pivotally mounted on the front frame. Each of the temple members 14, 16 may have a rear end portion 18 located opposite of the front frame. Generally, the eyeglasses 10 have a use position in which the front frame is positioned on the nose of the wearer and in front of the eyes of the wearer. The eyeglasses 10 may also have a stored position in which the front frame is positioned away from the face of the wearer and the front frame is rested on the visor of the cap.

In embodiments, the system 10 may include a cap 20 generally characterized having a top 22 and a bottom 24, a front 26 and a rear 28. The front 26 of the cap may be positioned above the face of the wearer during typical usage, and the rear 28 may be located opposite of the face on the head of the wearer. The cap 20 has opposite sides 30, 31 between the front and rear. The cap 20 also has an opening 32 at the bottom for receiving a portion of the wearer's head and has a peak at the top, opposite of the opening 32.

The cap 20 may comprise a crown 34 that extends from the bottom 24 to the top 22 of the cap and from the opening 32 to the peak of the cap. The crown 34 may be formed of a plurality of panels 36 which each may extend from the opening to the peak. Illustratively, the crown 34 of the cap has a midline 37 that extends from the peak or top 22 of the cap to the opening 32 and the midline may be positioned approximately midway or halfway between the forwardmost extent of the crown 34 and the rearward most extent of the crown.

The cap may also comprise a visor 38 that extends forwardly from the crown at the front of the cap so as to be positioned above the face of the wearer during usage of the cap.

The cap 20 may also comprise a perimeter band 40 that extends around the head of the user when the cap is worn on the head. The perimeter band 40 has an inward side 42 oriented toward the wearer's head and an outward side 44 oriented away from the wearer's head. The perimeter band 40 may include a closure structure 46 which is configured to adjust a circumferential size of the perimeter band to adjust the fit of the cap to the size of the wearer's head. In embodiments, the closure structure includes two band sections 48, 50 and a connector element 52 for connecting the two band sections together at different locations to affect different circumferential sizes of the perimeter band. The connecting element 52 may comprise, for example, a slide buckle or a series of posts engageable with a series of holes. The cap 20 may include a gap 54 between the crown 34 and the perimeter band 40 at the rear 28 of the cap, and the closure structure 46 may extend across the gap such that the gap accommodates constriction and extension of the closure structure 46 of the band to facilitate increasing and decreasing the circumferential size of the perimeter band.

In a significant aspect, the cap 20 includes a passage 58 extending along a portion of the perimeter band, and preferably may include a pair 58, 60 of the passages with each of the passages being located on one of the opposite sides 30, 31 of the cap. Each of the passages 58, 60 may be elongated and may extend along different portions of the perimeter band 40 on the sides of the cap. In the illustrative embodiments, the passages 58, 60 may be formed by the crown 34 and the perimeter band 40. Each of the passages 58, 60 may be located between the perimeter band and the portion of the material of the crown 34 that extends downwardly adjacent to the outward side 44 of the perimeter band.

Significantly, the cap 20 may also include a pair 62, 64 of forward apertures formed in the crown, or panels forming the crown, of the cap. Each of the forward apertures 62, 64 may be located at one of the sides 30, 31 of the cap and each of the forward apertures may be in communication with one of the passages so that each of the passages is in communication with one of the forward apertures. Conceptually, the forward apertures 62, 64 are located at the forward ends of the respective passages 58, 60. The forward apertures 62, 64 may be located adjacent to the inward side 42 of the perimeter band, generally adjacent to the lower edge of the crown forming the opening 32. Illustratively, each of the forward apertures may be located on the side of the cap at a location generally above the ear of the wearer when the cap is being worn by the wearer. The forward apertures may each be located approximately halfway between the forwardmost extent of the opening 32 of the crown and the rearwardmost extent of the opening of the crown. As a further example, each of the forward apertures 62, 64 may be located slightly forward of the seam between adjacent panels of the crown located at the side 30, 31 of the cap.

Additionally, the cap 20 may further include a pair 66, 68 of rearward apertures formed in the crown, or panels forming the crown. The rearward apertures 66, 68 are generally located rearwardly of the forward apertures. Each of the rearward apertures 66, 68 may be in communication with one of the passages. Conceptually, the rearward apertures 66, 68 are located at the rearward ends of the respective passages 58, 60. The rearward apertures 66, 68 may also be located adjacent to the inward side 42 of the perimeter band, generally adjacent to the lower edge of the crown forming the opening 32. Illustratively, the rearward apertures 66, 68 may be located on opposite sides of the gap 54, and each aperture may be located adjacent to the edge of the material of the crown forming the gap.

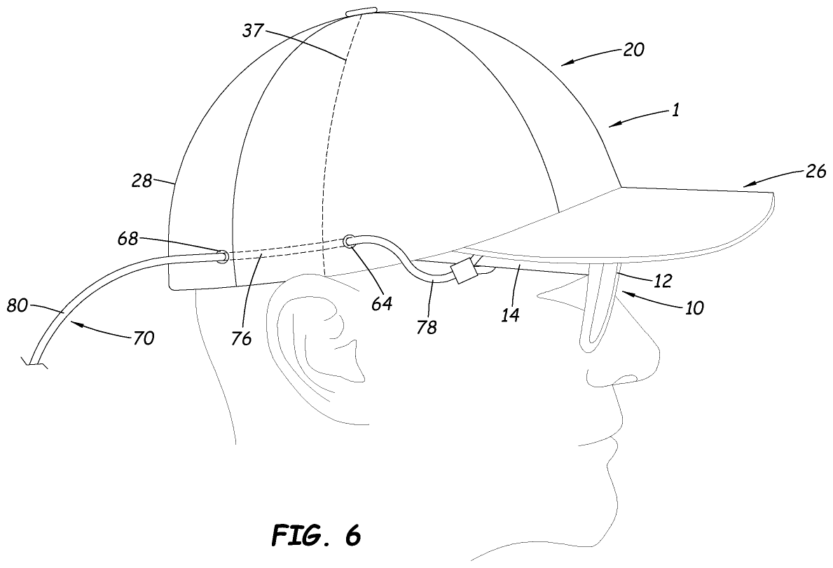

In some illustrative embodiments, such as is shown in FIG. 6, the forward apertures 64 may be located forward of the midline 37 of the crown and may be located between the midline and the front 26 of the cap. Further, the forward apertures 64 may be located between the midline 37 and a rearmost extent of the visor 38 of the cap. Further, the rearward apertures 68 may be located rearward of the midline 37 of the crown and may be located between the midline and the rear 28 of the cap.

The system 1 has a retaining assembly 70 mounted on the cap 20 for retaining the eyeglasses on the cap. The retaining assembly 70 may utilize features of the cap 20 described herein that are not typical of a cap, such as the forward and rearward apertures and the passage extending between the apertures. The retaining assembly 70 may be mounted on the cap via the passages 58, 60 of the cap. The retaining assembly 70 may be effective for securing the eyeglasses in the use position on the face of the wearer and also in the stored position on the visor of the cap.

In embodiments, the retaining assembly 70 includes a pair of straps 72, 74, with each strap being associated with one of the passages 58, 60 of the cap. In general, each of the straps is partially inserted into and located in one of the passages such that a medial portion 76 of the strap extends in one of the passages of the cap. A first portion 78 of each strap may extend from the passage into which it is inserted and out of the forward aperture associated with the passage. A second portion 80 of each strap may extend from the associated passage out of the rearward aperture of the passage. It should be recognized that each of the straps 72, 74 may comprise virtually any type of elongate member, such as a cord, tube, band, etc., whether solid or hollow.

For each of the straps, the first portion 78 has a first end 82 which is configured for attaching to one of the temples of the eyeglasses for securing the respective strap to the temple of the glasses. An attachment structure 84 may be located on the first end 82 to attach the first end to the temple of the eyeglasses. In the most highly preferred embodiments, the attachment structure 84 provides a removable attachment between the strap and the temple of the eyeglasses to permit interchange of different glasses with the retaining assembly. Illustratively, the attachment structure may comprise a loop formed on the first end 82 into which the end portion of one of the temples may be inserted. Optionally, the loop may be constricted about the temple to create the attachment, or the loop may be formed of the elastomeric material to permit stretching of the loop to insert the temple. In another example, the attachment structure 84 may be provided by the first end 82 of the strap having a tubular construction to accept an end portion of the temple. Other structures may be suitable for forming the attachment structure 84.

In some embodiments, the first ends 82 of the straps may be connectable to each other, such as when glasses are not attached to the retaining assembly, and may permit the first portion 78 and first ends 82 of the straps to rest upon the upper surface of the visor 38. In some embodiments, the attachment structure 84 on each of the first ends 82 of the straps may also be configured to attach together. For example, loops forming the attachment structure on each of the ends 82 for the temples of the glasses may also permit the ends 82 to be removably attached together.

Also, for each of the straps, the second portion 80 has a second end 84. While the second ends 84 of the respective straps may be loose with respect to each other, some preferred embodiments of the retaining structure have the second ends of the straps connected or attached together to resist unintentional movement of the second end into the rearward aperture and into the passage, and possibly out of the forward aperture such that the strap is disconnected from the cap. A breakaway structure 88 may be provided to connect the second ends of the respective straps in a manner that secures the ends together, but may also be configured to release the connection of the ends upon the application of force above a threshold level to provide a safe to release if the second portions of the connected straps were to be unintentionally caught upon a protruding object. The threshold level of force may be greater than the force that would normally be applied to the straps when adjusting the position of the straps in the passages, but may also be below the force that might injure the wearer's head or neck if not released. Illustrative breakaway structures may comprise a snap connection, a hook and loop fastener connection, and the like.

In embodiments, the straps 72, 74 and the passages 58, 60 are constructed in a manner that permits sliding of the strap through the passage to adjust a degree to which the first portions 78 of the straps extend out of the passages, and thus permits adjustment of the position of the eyeglasses attached to the straps with respect to the cap, for comfortably fitting the wearer's face or positioning the eyeglasses on the visor of the cap.

In some embodiments, the straps 72, 74 and the passages 58, 60 may be constructed in a manner that imposes a degree of resistance to the sliding of the straps through the respective passages such that the straps are held or maintained in a particular position with respect to the passage. The degree of resistance may be such that a degree of force is applied to the strap or straps by the user manually pulling on one of the portions of the straps causes the strap or straps to move through the passage. The degree of resistance to the movement of the straps through the passages may be increased or decreased by changing the material forming the strap and/or the passage, or by changing the character of the surface of the strap and/or the passage.

In some preferred embodiments, the straps 72, 74 are substantially unstretchable to substantially resist or prevent elongation of the strap between the first 82 and second 86 ends, which tends to reduce or eliminate any tension that may be applied by the straps to the eyeglasses, and in turn to the face of the wearer, when the glasses are in the use position.

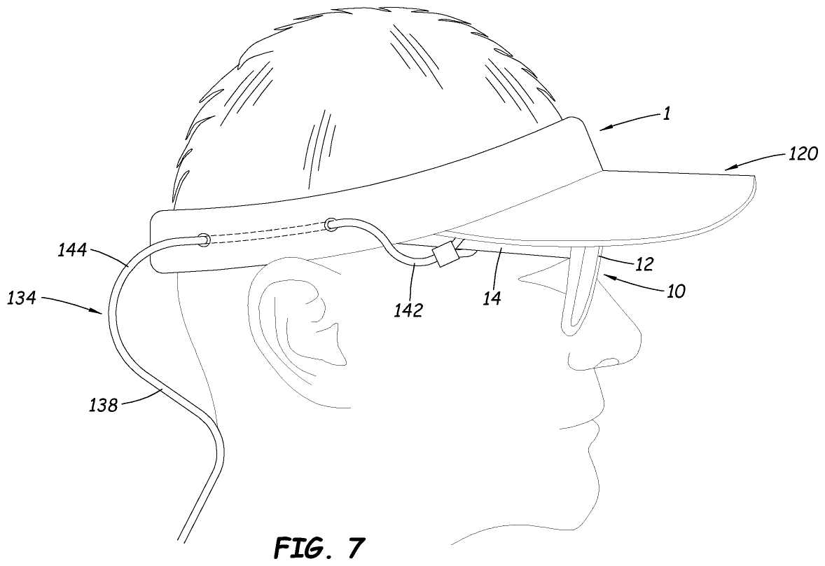

In another aspect, the disclosure relates to an article 90 of headwear with innovative features for securing eyeglasses to the wearer's head, such as is illustrated in FIGS. 7 through 9 of the drawings. The article 90 is a type of headwear that may be referred to as a “sports visor” or a “sun visor,” but typically comprises more than just a protruding feature of an article of headwear.

The article 90 may include a perimeter band 92 for extending around the head of the user when the article 90 is worn on the head. Notably, the article 90 of headwear lacks a crown above the perimeter band. The perimeter band 92 of the article has an inward side 94 oriented toward the wearer's head, and an outward side 96 oriented away from the wearer's head, when the article is being worn. The perimeter band 92 has an upper edge 98 and a lower edge 100 corresponding to the orientations of the edges when the article is being worn. The perimeter band may have an inner panel portion 102 forming at least a portion of the inward side 94 and an outer panel portion 104 forming at least a portion of the outward side 96. The perimeter band has a forward portion 106 and a rearward portion 108. The perimeter band 92 also has opposite first side 110 and second side 112 portions which extend between the front and rear portions.

The article 90 may also include a visor 120 for positioning above the face of the wearer when the article is worn, and the visor may extend forwardly from the perimeter band 92, such as from the forward portion 106 of the band.

The article 90 may further include a passage 122 extending along a portion of the perimeter band 92 and the passage may be formed by the perimeter band. Typically, the article 90 includes a pair 122, 124 of the passages each extending along different portions of the perimeter band, with the passages being located on opposite side portions 110, 112 of the band. Each of the passages may be elongated along the sides, and each passage may traverse the midline of the band. Each passage 122, 124 may be formed between the inner panel portion 102 and the outer panel portion 104 of the perimeter band.

A pair 126, 128 of forward apertures may be formed in the perimeter band of the article, and each of the forward apertures may be formed in a respective one of the side portions 110, 112 of the band. Illustratively, each of the forward apertures may be formed in one of the outer panel portions 104 of the band. Each of the forward apertures 126:28 may be in communication with a respective one of the passages 122, 124. A pair 130, 132 of rearward apertures may be formed in the perimeter band of the article, and each of the rearward apertures may be formed in a respective one of the side portions 110, 112 of the band. Illustratively, each of the rearward apertures may be formed in one of the outer panel portions 104 of the band. Each of the rearward apertures may be in communication with a respective one of the passages 122, 124.

The article 90 of headwear may include a retaining assembly 134 mounted on the article for retaining the eyeglasses on the article. The retaining assembly 134 may be mounted on the passages 122, 124 of the article. In greater detail, the retaining assembly 134 may comprise a pair of straps 136, 138. Each strap may have a medial portion 140 which extends in one of the passages 122, 124, and each strap may also have a first portion 142 which extends out of a respective passage through the forward aperture 126, 128 of the passage. Each strap 136, 138 may further have a second portion 144 which extends out of a respective passage through the rearward aperture 130, 132 of the passage. The first portion 142 of each strap may have a first end 146 which is configured for attaching to one of the temples of the eyeglasses. The second portion 144 of each strap may have a second end 148 which is configured for attaching to the second end of the other strap.

The retaining assembly 134 may further comprise a breakaway device 150 that connects the straps 136, 138 together toward the respective second ends 148 of the straps.

In some further embodiments, the retaining assembly 70 may comprise at least one strap structure, and the strap structure may comprise a single strap structure. The strap structure may comprise a pair of medial portions positioned in each of the passages of the article such that the medial portions are each located between the inward panel portion and the outward panel portion of the perimeter band. The strap structure may also comprise a pair of first portions with each of the first portion extending out of a respective one of the passages through the respective forward aperture in the perimeter band associated with the passage, and then extends out of the respective passage of the perimeter band. The strap structure may further comprise a pair of second portions with each of the second portions extending out of a respective one of the passages through the respective rearward aperture associated with the passage, and then extends out of the respective passage of the perimeter band. The strap structure may further comprise a pair of first ends each located on one of the first portions of the strap, with each first end being configured for attaching to a temple member of the eyeglasses.

It should be appreciated that in the foregoing description and appended claims, that the terms “substantially” and “approximately,” when used to modify another term, mean “for the most part” or “being largely but not wholly or completely that which is specified” by the modified term, and may be further quantified as values or qualities which deviate approximately 10 percent or less from the value or quality or relationship stated in the disclosure.

It should also be appreciated from the foregoing description that, except when mutually exclusive, the features of the various embodiments described herein may be combined with features of other embodiments as desired while remaining within the intended scope of the disclosure.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated.

With respect to the above description then, it is to be realized that the optimum dimensional relationships for the parts of the disclosed embodiments and implementations, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present disclosure.

Therefore, the foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that fall within the scope of the claims.

I claim:

1. A system for securing eyeglasses to a head of a person, the eyeglasses being of a type having a front frame and a pair of temple members extending from the front frame, the system comprising:
an article of headwear for being worn by the person, the article having a front and a rear, and opposite sides, the article having an opening at the bottom for receiving a portion of the head of the person, the article comprising:
a perimeter band for extending around the head of the user when the article is worn on the head, the perimeter band defining the opening of the article, the perimeter band having an inward side oriented toward the head of the user when the article is worn and an outward side oriented away from the head of the user when the article is worn, the perimeter band including an inward panel portion forming at least a portion of the inward side and an outward panel portion forming at least a portion of the outward side; and
a visor extending forwardly from the perimeter band at the front of the article for positioning above the face of the person;
a pair of passages extending along different side portions of the perimeter band, each of the passages being formed between the inward panel portion and the outward panel portion of the perimeter band;
a pair of forward apertures formed in the outward side of the perimeter band, each of the forward apertures being located on one of the sides of the article and being in communication with one of the passages; and
a pair of rearward apertures formed in the outward side of the perimeter band, each of the rearward apertures being located on one of the sides of the article and rearwardly of one of the forward apertures, each of the rearward apertures being in communication with one of the passages such that each of the passages extends between one of the forward apertures and one of the rearward apertures on a said side of the article; and
a retaining assembly mounted on the article for retaining eyeglasses on the article, the retaining assembly comprises:
a pair of straps with each of the straps having:
a medial portion extending in one of the passages of the article such that the medial portion is located between the inward panel portion and the outward panel portion of the perimeter band;
a first portion extending through the forward aperture formed in the perimeter band such that the first portion extends out of the said passage of the perimeter band; and
a second portion extending through the rearward aperture formed in the perimeter band such that the second portion extends out of the said passage of the perimeter band;
a first end on the first portion of the strap being configured for attaching to a temple member of the eyeglasses; and
a second end on the second portion of the strap being attached to the second end of the other said strap.

2. The system of claim 1 wherein the straps and the passages are constructed in a manner that permits sliding of the medial portion of the strap through the passage associated with the strap to permit adjustment of a degree to which the first portions of the straps extend out of the passages.

3. The system of claim 1 wherein the straps and the passages are constructed in a manner that imposes a degree of resistance to the sliding of the straps through the passages that permits the straps to be held in a particular position with respect to the passage.

4. The system of claim 1 wherein the straps are substantially unstretchable to substantially prevent elongation of the straps between the first and second ends of the straps.

5. The system of claim 1 wherein the second ends of the straps are releasably connected together by a breakaway device permitting disconnection of the second ends from each other upon application of force on one of the straps exceeding a threshold level of force.

6. The system of claim 1 wherein each of the forward apertures is located approximately halfway between a forwardmost extent of the crown and a rearwardmost extent of the crown.

7. The system of claim 1 wherein each of the forward apertures is located on a said side of the article approximately halfway between the front and the rear of the article.

8. The system of claim 6 wherein each of the rearward apertures is located rearward of a point located approximately halfway between the forwardmost extent of the perimeter band and the rearwardmost extent of the perimeter band.

9. The system of claim 1 wherein the perimeter band at the rear of the cap is configured to facilitate constriction and extension of the band.

10. The system of claim 1 additionally comprising the eyeglasses, each of the temple members having a rear end portion opposite of the front frame; and
wherein the first end of each of the straps is attached to one of the rear end portions of the temples.

11. A system for securing eyeglasses to a head of a person, the eyeglasses being of a type having a front frame and a pair of temple members extending from the front frame, the system comprising:
an article of headwear for being worn by the person, the article having a front and a rear, and opposite sides, the article having an opening at the bottom for receiving a portion of the head of the person, the article comprising:
a perimeter band for extending around the head of the user when the article is worn on the head, the perimeter band defining the opening of the article, the perimeter band having an inward side oriented toward the head of the user when the article is worn and an outward side oriented away from the head of the user when the article is worn, the perimeter band including an inward panel portion forming at least a portion of the inward side and an outward panel portion forming at least a portion of the outward side; and
a visor extending forwardly from the perimeter band at the front of the article for positioning above the face of the person;
a pair of passages extending along different side portions of the perimeter band, each of the passages being formed between the inward panel portion and the outward panel portion of the perimeter band;
a pair of forward apertures formed in the outward side of the perimeter band, each of the forward apertures being located on one of the sides of the article and being in communication with one of the passages; and
a pair of rearward apertures formed in the outward side of the perimeter band, each of the rearward apertures being located on one of the sides of the article and rearwardly of one of the forward apertures, each of the rearward apertures being in communication with one of the passages such that each of the passages extends between one of the forward apertures and one of the rearward apertures on a said side of the article; and
a retaining assembly mounted on the article for retaining eyeglasses on the article, the retaining assembly comprising:
at least one strap structure having:
a pair of medial portions positioned in each of the passages of the article such that the medial portions are each located between the inward panel portion and the outward panel portion of the perimeter band;
a pair of first portions with each said first portion extending out of a said passage through a said forward aperture in the perimeter band and out of the said passage of the perimeter band;
a pair of second portions with each said second portion extending out of a said passage through a said rearward aperture in the perimeter band and out of the said passage of the perimeter band; and
a pair of first ends each located on one of the first portions of the strap, each first end being configured for attaching to a temple member of the eyeglasses.
